(19) United States
(12) Patent Application Publication
(10) Pub. No.: US 2023/0034451 A1
(43) Pub. Date: Feb. 2, 2023

(54) POWER CABLE ASSEMBLY FOR A POWER DISTRIBUTION SYSTEM HAVING AN INTEGRATED COOLING SYSTEM

(71) Applicant: Aptiv Technologies Limited, St. Michael (BB)

(72) Inventors: Monika PIESZKA-LYSON, Kraków (PL); Dominik KAWALEC, Brzoskwinia (PL); Pawel KOZAK, Kraków (PL); Grzegorz POREBSKI, Podleze (PL); Grzegorz PALETKO, Zabierzów (PL)

(21) Appl. No.: 17/876,365

(22) Filed: Jul. 28, 2022

(30) Foreign Application Priority Data
Jul. 30, 2021 (EP) 21188761.7

(51) Int. Cl. H01B 7/42

(52) U.S. Cl. CPC H01B 7/423

(57) ABSTRACT

A high voltage power cable assembly includes an electrically conductive and thermally conductive conductor. The electrical conductor extends longitudinally between first and second end contact surfaces configured for coupling via first and second connectors to electrical connections. The electrical conductor comprises an internal surface and an external surface, wherein the internal surface defines an interior channel configured for receiving a dielectric coolant from a cooling system arranged in communication with the electrical conductor; and wherein the internal surface is an electrically conductive heat transfer surface arranged to be in direct contact with the dielectric coolant for transferring heat from the conducting body to the dielectric coolant.

### CROSS-REFERENCE TO RELATED APPLICATION

This application claims benefit of priority to European Patent Application No. 21188761.7 filed on Jul. 30, 2021, the entire disclosure of which is hereby incorporated by reference.

### TECHNICAL FIELD OF THE INVENTION

The present application relates in general to a power cable assembly, and more particularly, to a high voltage power cable assembly for a power distribution system incorporating an integrated cooling system.

### BACKGROUND

Charging of high voltage batteries, for example, in the field of automotive technology, requires the use of heavy gauge high voltage (HV) power cables that can handle the level of current required to ensure fast charging. The HV power cables used in battery charging applications and/or power distribution applications are usually provided with a cooling system to ensure that the heat generated at the electrical conductor due to the high current flow is dissipated away, thereby increasing the efficiency and safety of the charging operation.

In one existing approach of the prior art, passive cooling solutions may be applied to reduce the temperature dissipated by an HV power cable. However, passive cooling solutions are limited due to manufacturing and weight constraints. For example, changing the dimensions of the components, e.g., increase the electrical conductor gauges to reduce temperature, would increase the weight and cost of the power cable assembly while reducing its flexibility.

Examples of known cable cooling systems are described in KR102120306 and WO201860151. Typically, known power cable assemblies use one or more busbars to carry the electrical power and large heat sinks or air-cooling units that are designed to dissipate the heat generated during operation at the busbar.

Therefore, there is a need to provide a power cable assembly with an improved cooling system that addresses the above noted problems.

### SUMMARY

It is an aim of the present disclosure to provide an improved power cable assembly and an improved power distribution system that addresses the problems described above.

According to a first aspect, the arrangements of the specification provide a high voltage power cable assembly that includes an electrical conductor and a first insulating layer surrounding the electrical conductor. The electrical conductor extends longitudinally between first and second end contact surfaces configured for coupling via first and second connectors to respective electrical connections. The electrical conductor has an internal surface and an external surface and a conducting body therebetween. The internal surface defines an interior channel between a first end opening and a second end opening configured for receiving a dielectric coolant from a cooling system arranged in communication with the electrical conductor. The internal surface is an electrically conductive heat transfer surface arranged to be in direct contact with the dielectric coolant for transferring heat from the conducting body to the dielectric coolant.

The arrangements of the specification and claims advantageously provide improved heat exchange between the dielectric coolant and the conductor as the coolant is provided in direct contact with the heat transfer surface of the conductor. The improved heat exchange for cooling provides improved conductivity and further that the cross section of the conductor may be decreased in comparison with typical HV conductors, HV busbars or HV cable cross-sections.

In one arrangement the electrical conductor is configured for coupling via first and second connectors to a node of an electrical power supply and a battery respectively.

In one arrangement, the electrical conductor may comprise a tubular or cylindrical form but may also have other shapes such as square or rectangular. In another arrangement, the electrical conductor may comprise an electrically conductive and thermally conductive busbar. The electrical conductor is comprised of a metal material. The metal may comprise one or more of copper, copper ETP, and/or a copper alloy. The metal may comprise aluminium and/or an aluminium alloy.

In one arrangement the power cable assembly, the first insulating layer may surround or envelop the external surface of the electrical conductor. In a second arrangement the power assembly may further comprise a shielding layer surrounding the first insulating layer, and a second insulating layer external to the shielding layer. The shielding layer may comprise one of braid, pipe, or bundle shielding.

The arrangements of specification are advantageously configured for use and operation across a wide range of current loads for example from 100 to 900 amperes, the form, structure and dimensions of the power cable assembly may be adjusted as required for load and to provide the required thermal response levels.

The power cable assembly of arrangements of the specification is configured for coupling to a cooling system. In a further arrangement, for and in operation, the power cable assembly may be coupled to a cooling system.

According to a further aspect there is provided a cooling system configured for coupling with a power cable assembly of arrangements of the specification, the cooling system is configured to circulate the dielectric coolant between a coolant inlet and a coolant outlet, via the interior channel of the electrical conductor. The cooling system includes a pump a cooling unit, and one or more connectors for connecting the coolant inlet and the coolant outlet to the power cable assembly. The dielectric coolant is circulated in direct contact with the heat transfer surface of the electrical conductor.

The electrical conductor defines a coolant pipe, and the dielectric coolant is receivable in the coolant pipe. In operation the coolant is circulated therethrough. The dielectric coolant is thermally coupled to heat transfer surface of the electrical conductor to provide heat transfer therefrom to the coolant.

The arrangements of the claims advantageously provide an internal and integrated cooling system. Providing an electrical conductor or busbar having an internal channel as the electrical conductor and comprising a heat transfer surface, enables cooling concurrent with operation. Providing concurrent coolant flow allows improved cooling and heat transfer to maintain the high voltage system at the required levels of operating temperature. The provision of power cable assembly operable with an integrated cooling system advantageously allows for increased responsiveness depending on operating conditions, for example coolant flow rate may be adjusted as required.

The dielectric coolant may comprise a dielectric liquid. The dielectric coolant may comprise for example one of the following: (i) 3M FLUORINERT FC-43, (ii) 3M NOVEC 7500; (iii) the coolant comprises transformer oil. Other suitable dielectric coolants may also be used.

The dielectric coolant may have a withstand voltage level of at least 1.5 kV; or at least 6 kV. A coolant having a particular different withstand voltage strength may be selected based on operational voltage levels.

The arrangement of the specification provides for the dielectric coolant to be in direct contact with the heat transfer surface of the electrical conductor and as such advantageously provides internal cooling of the conductor without current leakage. Providing a dielectric coolant advantageously avoids current leakage.

The coolant inlet and the coolant outlet may be arranged according to one of the following: the inlet and outlet may be located at opposite ends of the electrical conductor tube; or alternatively the inlet and outlet may be located at the same end of the electrical conductor tube.

According to a further aspect, the arrangements of the specification provide a power distribution system comprising a power cable assembly according to arrangements of the specification and an integrated cooling system according to arrangements of the specification.

In one arrangement the power distribution system comprises a power cable assembly and an integrated cooling system. The power cable assembly includes an electrical conductor that extends longitudinally between first and second end contact surfaces at first and second ends thereof. The power cable assembly is configured for coupling via first and second connectors between respective electrical connections. The electrical conductor has an internal surface and an external surface and a conducting body therebetween and a first insulating layer surrounding the electrical conductor. The internal surface defines an interior channel, between a first end opening and a second end opening. The internal surface is an electrically conductive heat transfer surface. The cooling system includes a pump and a cooling unit. A dielectric coolant is circulated through the interior channel of the electrical conductor between a coolant inlet and a coolant outlet via the cooling unit. The dielectric coolant is circulated in direct contact with the heat transfer surface of the electrical conductor to provide heat transfer from the electrical conductor to the coolant.

In one arrangement the electrical conductor is configured for coupling via first and second connectors between a node of an electrical power supply and a battery respectively, to provide power for charging the battery.

In one arrangement the system comprises one or more connectors for connecting the coolant inlet and the cooling outlet to the cooling unit. The electrical conductor may comprise an electrically conductive and thermally conductive busbar. The power distribution system provides a first electrical conducting channel and a second closed loop circuit coolant flow channel. The first and second channels are arranged in parallel.

### BRIEF DESCRIPTION OF THE DRAWINGS

The present invention is now described, by way of example with reference to the accompanying drawings, in which:

FIG. 1 is a perspective view of an exemplary power cable assembly according to embodiments of the present disclosure;

FIG. 2 provides a transverse cross-sectional view of the power cable assembly of FIG. 1;

FIG. 3 is a perspective view of an exemplary power cable assembly according to embodiments of the present disclosure;

FIG. 4 provides a transverse cross-sectional view of the power cable assembly of FIG. 1;

FIG. 5 is an enlarged break-out view of the layers of the power cable assembly of FIGS. 1 and 2;

FIG. 6 is an enlarged break-out of the layers of the power cable assembly of FIGS. 3 and 4;

FIG. 7 is a block diagram illustrating an exemplary power cable assembly according FIG. 1 or 2 coupled to an exemplary cooling system according to embodiments of the present disclosure; and

FIG. 8 is a block diagram illustrating an exemplary power distribution system comprising a power cable assembly and an integrated cooling system according to embodiments of the present disclosure.

### DETAILED DESCRIPTION

The following disclosure provides many exemplary embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

For simplicity and clarity of illustration, reference numerals may be repeated among the Figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limiting to the scope of the examples described herein.

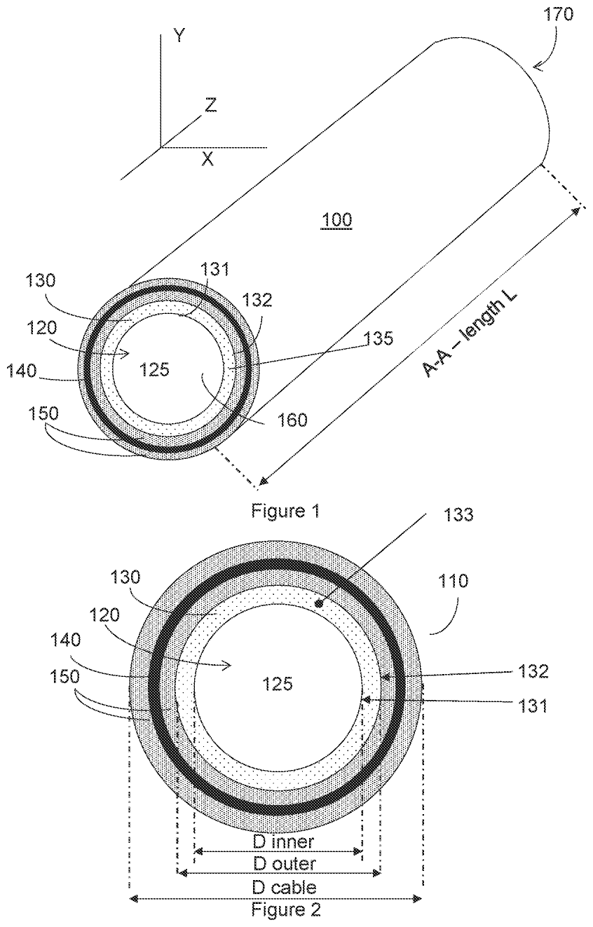

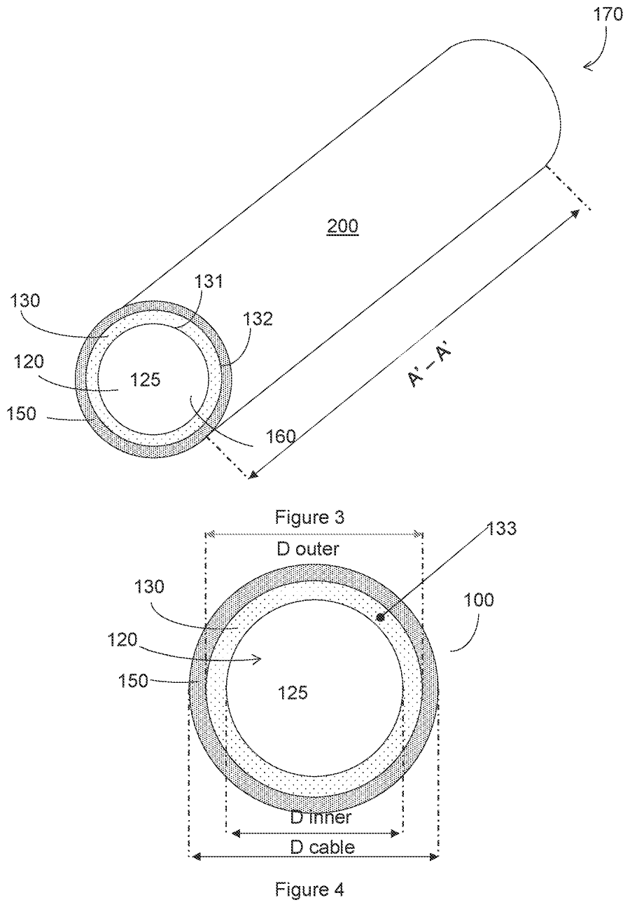

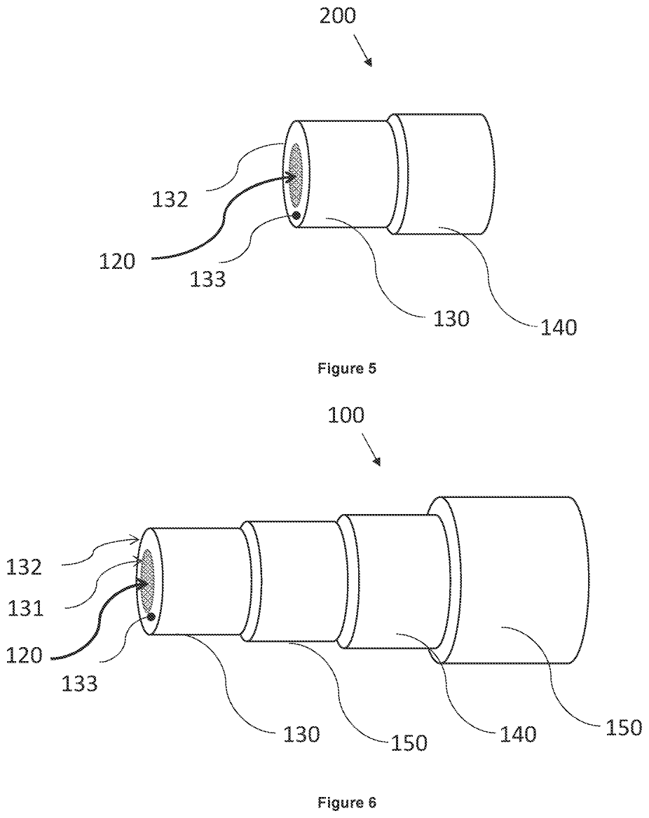

A power cable assembly 100 according to specification is described with reference to the Figures and initially in particular with reference to FIGS. 1, 2 and 5. With reference to FIGS. 3, 4 and 6 an alternative exemplary power cable assembly 200 is described. The power cable assemblies 100, 200 include many features in common and common reference numbers have been used where appropriate.

The power cable assembly 100, 200 comprises an electrical conductor 130. The power cable assembly 100 has a longitudinal axis (that extends in the z-direction as illustrated in FIG. 1), between first and second ends thereof The features of the power cable assembly 100 are arranged about the longitudinal axis thereof

The power cable assembly 100, 200 comprises an electrical conductor 130. The electrical conductor 130 is both electrically conductive and thermally conductive. The electrical conductor 130 extends longitudinally between a first contact end surface 135 and a second end contact surface 135 at opposing first and second ends of the electrical conductor 130 and of the power cable assembly 100. The contact surfaces 135 are conducting surfaces. The electrical conductor 130 is configured for coupling via first and second connectors to respective electrical connection. For example, the electrical conductor may be configured for coupling via a node of an electrical power supply at a first end and a battery at a second, respectively. The electrical conductor 130 is configured for connecting to a power distribution system.

Accordingly, the power cable assembly 100, 200 may for example be used in applications including for the delivery of power from a power supply to provide charging of a battery of a car. The high voltage power cable assembly 100, 200 may be a flexible cable.

The electrical conductor 130 comprises an internal surface 131 and an external surface 132 and a conducting body 133 extending there between. The internal surface 131 defines an interior channel 120 that extends between a first end opening 160 and a second end opening 170. The interior channel 120 is configured for receiving a coolant from a cooling system 300 arranged in fluid communication with the electrical conductor 130.

The electrical conductor 130 has a tubular or pipe form. The coolant comprises a dielectric coolant 125. The coolant 125 circulates through the interior channel 120, as illustrated in the drawings. The electrical conductor 130 defines a coolant pipe for the dielectric coolant 125 and also defines the electrically conducting body 133. The dielectric coolant is circulated through the interior channel 120 of the electrical conductor 130.

In the exemplary arrangements of FIGS. 1 to 6 the overall power cable assembly 100, 200 and the electrical conductor 130 have a generally cylindrical form and extend radially about their longitudinal axis. As illustrated, in transverse cross-section (X-Y plane with reference to FIG. 1), the power cable assembly 100, 200 and the electrical conductor 130 are generally of circular form or ring form. It will however be appreciated that while the electrical conductor 130 of the exemplary arrangements of the drawings has a generally circular or ring form in cross-section, an electrical conductor of other suitable forms may also be used. The electrical conductor 130 may for example have an oval or square or rectangular form in cross-section. The electrical conductor 130 may be a busbar that is both electrically conductive and thermally conductive and having a tubular or pipe form defining a coolant pipe. The electrical conductor 130 comprises a single unitary body form.

Referring to the Figures, the electrical conductor 130 of the exemplary power cable assemblies 100, 200 has a length L in the longitudinal direction. The interior channel 120 has a diameter dᵢₙ, which together with the radius, and the length of the electrical conductor 130 defines the volume V_{channel} of the interior channel 120, the volume of coolant that can be received therein, and the surface area of the inner channel. The electrical conductor 130 has an inner radius and inner diameter dᵢₙ, and an outer radius and outer diameter dₒᵤₜ. The diameters are shown in FIGS. 2 and 4. The conducting web or wall of the electrical conductor 130 that extends transversely or radially between the internal and external surfaces defines the electrically conducting body 133. The conducting body has a depth dₒᵤₜ−dᵢₙ. In the case of the exemplary arrangement of FIG. 2 (or FIG. 4) the depth is a radial distance, the difference between the outer radius and the inner radius of the electrical conductor 130.

The depth or thickness of the conducting body 133 of the electrical conductor 130, the inner and outer diameters and radii, together with the length L defines the volume V_{conductor} of the conducting body 133. The volume, form, and dimensions of the electrical conductor 130 and the interior channel 120 may be varied and are selected to provide the required levels of cooling for the power cable assembly. The area of the internal surface 131 of the electrical conductor which defines the heat transfer surface, may also be varied, and is selected to provide the required contact area between the dielectric coolant and the heat transfer surface. For example, the form, dimensions, and volume of coolant relative to the volume of the conductor body may be selected based on operational requirements, for example taking account of current and operating temperature requirements.

The internal surface 131 of the electrical conductor 130 is a heat transfer surface. The internal surface 131 of the electrical conductor 130 is electrically conductive and heat conducting. The internal surface 131 is arranged to be in direct contact with the dielectric coolant 125, receivable in the interior channel 120, to transfer heat directly from the electrical conductor 130 to the dielectric coolant 125. In operation, heat that is generated in electrical conductor 130 as current passes through the conducting body 133 is transferred via the internal surface 131 to the coolant 125.

The provision of the dielectric coolant 125 in direct contact with the heat transfer surface, the internal surface 131 of the electrical conductor 130 provides for an improved heat transfer from the electrical conductor to the coolant. Therefore, the dielectric coolant 125 is thermally coupled to the electrically conductive heat transfer surface 131 to allow heat transfer from electrical conductor 130 to the coolant 125.

The electrical conductor 130 defines a coolant pipe for the dielectric coolant 125. The dielectric coolant 125 is circulated though the interior channel 120 of the electrical conductor 130 in direct contact with the internal surface 131 of the electrical conductor 130 between the first end opening 160 and the second end opening 170. The electrical conductor 130 is electrically and thermally conductive, and the dielectric coolant 125 is in thermal contact with the heat conducting internal surface 131.

The arrangement of the specification provides the dielectric coolant 125 in direct contact with the heat transfer surface 131 of the electrical conductor 130 and as such provides internal cooling of the electrical conductor 130 without current leakage. Providing the dielectric coolant 125 in direct contact with the electrical conductor 130 advantageously avoids current leakage.

The power cable assembly 100, 200 comprises a high voltage, HV, power cable. The power cable assembly 100, 200 is configured for delivery of high current loads. The electrical conductor is a high voltage (HV) conductor.

In further detail, the electrical conductor 130 is comprised of a metal material. The metal may comprise for example: copper, copper ETP (electrolytic tough-pitch copper), or a copper alloy. In an alternative arrangement the metal may comprise aluminium or an aluminium alloy. However, it will be appreciated that other suitable alternative materials may be used.

The power cable assembly 100 of FIGS. 1, 2 and 5 comprises first and second layers of insulation and a shielding layer 140 therebetween. In this regard, the power cable assembly 100 comprises:
a first insulating layer 150 surrounding the external surface 132 of the electrical conductor 130;
a shielding layer 140 surrounding the first insulating layer 150;
a second insulating layer 150 external to the shielding layer 140.

In an alternative embodiment, the power cable assembly 200 of FIGS. 3, 4 and 6 comprises a first insulating layer 150 surrounding the external surface 132 of the electrical conductor 130.

The insulation material may for example be polyamide (PA) 11, PA 12, cross-linked polyolefin (XLPO), or silicone. However, it will be appreciated that any suitable insulation material may be used.

The shielding layer 140 may for example be braid, pipe, or bundle shielding. However, it will be appreciated that any suitable alternative shielding may be used.

The specification provides a power cable assembly 100 that is shielded and a power cable assembly 200 that is unshielded. The power cable assembly 100 or 200 is selected including based on current load. The power cable assembly operable with the integrated cooling system provides an improved temperature response and thermal behaviour at all current levels, for the respective cable types. The arrangement of the specification allows for the operating temperature to be maintained at desired levels.

The coolant 125 has dielectric properties and accordingly is configured to be used and circulated in direct contact with the electrical conductor 130 to be cooled. The dielectric coolant 125 comprises a dielectric liquid. In a preferred arrangement, the dielectric coolant is a fully dielectric liquid. In preferred arrangements of the specification, the dielectric coolant may comprise, for example, one of the following:
3M FLUORINERT FC-43; or
3M NOVEC 7500;
the coolant may comprise a transformer oil; or
other liquid coolant with dielectric properties.

However, it will be appreciated that the above dielectric coolants are provided as examples of suitable dielectric coolants for use in the arrangement of the specification, and that other suitable coolants may also be used.

The withstand voltage level of the dielectric coolant 125 may be at least 1.5 kV or in an alternative arrangement 6 kV. The withstand voltage level will be selected taking account of the voltage applied to the power cable assembly, this allows selection of an appropriate dielectric material.

The dielectric coolant 125 may be selected according to properties of the coolant and requirements and applications.

For example, a coolant having the following properties may be selected for applications of the exemplary arrangements of the present specification.
Boiling point >100° C.
Liquid density—preferably <2000 kg/m3
Viscosity <100 cSt @ 20° C.

The specification provides cooling arrangements for a power cable assembly 100, 200. The cooling arrangement comprises a dielectric coolant 125 that is configured to be received directly in contact with a heat transfer surface 131 of an electrical conductor 130. The dielectric coolant 125 is circulated by a cooling system 300 in direct contact with the electrical conductor 130.

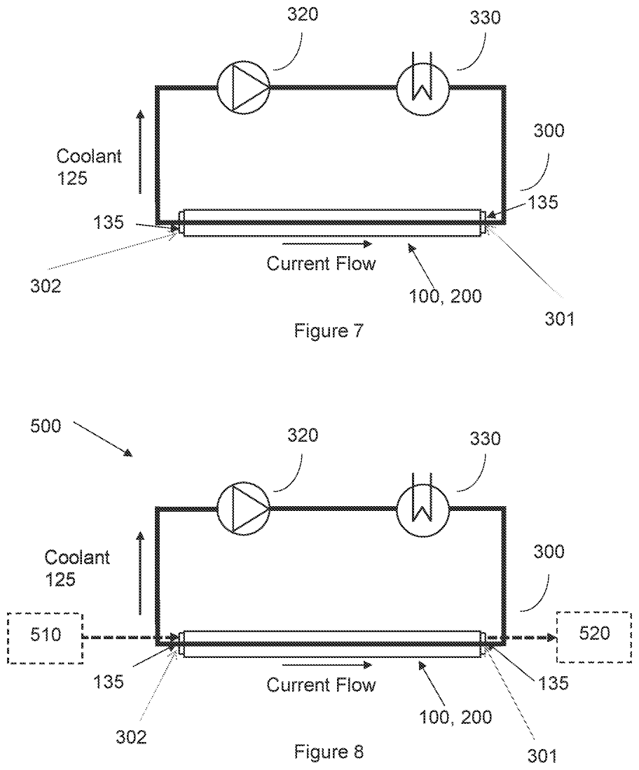

Referring to FIGS. 7 and 8, an exemplary power distribution system 500 comprising the power cable assembly 100, 200 and an integrated cooling system 300 is described. The power cable assembly 100, 200 is coupled to the cooling system 300.

The cooling system 300 of FIGS. 7 and 8 comprises a pump 320 and a cooling unit 330. The power cable assembly 100, 200 is configured for connection to the cooling system 300. The coolant inlet 301 and the coolant outlet 302 are configured for connection using one or more connectors to the power cable assembly

In operation, the coolant, dielectric coolant 125, is circulated through the interior channel 120 of the electrical conductor 130 of the power cable assembly 100, between a coolant inlet 301 and a coolant outlet 302.

In the exemplary arrangement of FIG. 7, the coolant inlet 301 and coolant outlet 302 are located at opposite ends of the power cable assembly 100. It will, however, be appreciated that in an alternative arrangement the inlet 301 and outlet 302 may be located at the same end, the first end of the power cable assembly—in such an arrangement a U-bend or connector or other coolant flow return feature would be provided at the second end of the power cable assembly.

The cooling system 300 comprises a closed loop coolant circulation system. The coolant 125 is circulated by the pump 320 through the interior channel 120 of the electrical conductor 130, between the inlet 301 and outlet 302 and via the cooling unit 330. The dielectric coolant 125 is circulated in direct contact with the electrical conductor 130. The cooling system 300 is configured for coupling to the coolant inlet 301 and the coolant outlet 302 using one or more connectors.

The power distribution system 500 comprises an integrated cooling system 300. The arrangement defines an internal cooling system. The power cable assembly is connectable to a cooling system and operable with an integrated cooling system.

In an exemplary arrangement, the power distribution system and the power cable assembly are configured for connection between a power supply 510 and a battery 520. As described above the first and second end contact surfaces 135 of the electrical conductor 130 of the power cable assembly 100 are configured for coupling via first and second connectors to a node of an electrical power supply at a first end and a battery at a second end, respectively. The contact surfaces 135 of the electrical conductor 130 are the conducting end surfaces at the first and second ends of the power cable assembly. Similarly, the interior channel 120 through which the coolant 125 is circulated, is configured for coupling to the cooling system 300 via one or more connectors. The coolant inlet 301 and outlet 302 are thus coupled to the cooling unit 330 and pump 320 and to the power cable assembly.

The power distribution system 500 in effect comprises an electrical conducting channel and a coolant flow or circulation channel, arranged in parallel.

Typically, high voltage conductors may experience high operating temperatures. For example, XLPO cables are designed for temperature level up to 150° C. and Silicone ones even up to 180° C.

During operation of the power distribution system 500, as current flows through the power cable assembly 100, the electrical conductor 130, heat will be generated.

The dielectric coolant 125 is circulated through the electrical conductor 130, to absorb heat therefrom by heat transfer to the dielectric coolant. The circulation of the dielectric coolant 125 in direct contact with the electrical conductor 130 advantageously avoids current leakage and provides for an improved heat transfer from the electrical conductor 130 to the coolant 125 and an improved cooling.

The power distribution system 500 with integrated cooling system according to the specification allows in exemplary arrangements for operating temperature rise (temperature above ambient temperature) to be maintained in the range of <50 K Dependent on conductor cross section, different current loads may be applied to reach Tᵣᵢₛₑ<50K.

### EXAMPLE 1

In an exemplary arrangement, according to the specification, a busbar or electrical conductor 130 has a cross-sectional area of 35 mm². The power cable assembly has an outer diameter d_{cable} of 19.1 mm with shielding (or an outer diameter d_{cable} of 14.5 mm without shielding). The interior channel 120 has a diameter of 10 mm and a flow rate of coolant of 1.5 l/min is provided. In these exemplary arrangements, current carrying capability may for example be 800-900 A (Tᵣᵢₛₑ<50K).

The electrical conductor of the example may have—radial extent/thickness in the range of 10 mm² to 95 mm².

According to the specification there is provided a power distribution system 500 comprising a power cable assembly 100, 200 and an integrated cooling system 300, the power cable assembly includes an electrically conductive and thermally conductive electrical conductor 130. The electrical conductor 130 extends longitudinally between first and second end contact surfaces 135. The electrical conductor 130 has an internal surface 131 and an external surface 132 and a conducting body 133 therebetween. The internal surface 131 defines an interior channel 120, between a first end opening 160 and a second end opening 170. The internal surface 131 is an electrically conductive heat transfer surface. The cooling system includes a coolant 125, a pump 320 and a cooling unit 330. The coolant is circulated through the interior channel 120 of the electrical conductor130 between a coolant inlet 301 and outlet 302 via the cooling unit 330. The coolant is a dielectric coolant 125 thermally coupled to the electrically conductive heat transfer surface to provide heat transfer from the electrical conductor 130 to the coolant.

The system further includes one or more connectors for connecting the coolant inlet and outlet to the power cable assembly. The electrical conductor may be an electrically conductive and thermally conductive busbar. The power distribution system provides a first electrical conducting channel and a second closed loop circuit coolant flow channel. The first and second channels are arranged in parallel.

This disclosure provides power cable assembly arrangements and power distribution system arrangement comprising a power cable assembly and integrated cooling system which advantageously provide improved cooling and improved heat transfer from a conductor to a coolant to provide improved operation.

Advantageously, the coolant is provided in direct contact with the conductor. Improved heat exchange is provided between the dielectric coolant and the conductor as the coolant is provided in direct contact with the heat transfer surface of the conductor. Further, the conductor of the power cable assembly has a single unitary body form to which effective cooling is provided. This is advantageous in comparison with previous arrangements that provided the conductor as separate insulated conducting wires. The improved heat exchange and cooling provides improved conductivity. Further the cross section of the conductor may be decreased in comparison with typical HV conductor or HV busbar, or HV cable cross-sections.

The cross-section of the conductor of the arrangement of the claims may be decreased 3-5 times in comparison with typical HV busbar/conductor/cable. For example a typical copper cable with conductor cross section of close to 120 mm², which may be replaced by a cooled conductor having a cross section of approximately 35 mm².

The arrangements of the specification provide solutions to the problems associated with large amounts of heat generated on a typical power distribution or cable charging system, including for example a harness or a high voltage power assembly, during charging of an electric vehicle. Providing an electrical conductor having an internal channel as the electrical conductor, as described and defined in the claims, enables concurrent coolant flow to provide improved cooling and heat transfer to maintain the high voltage system at the required safe levels of operating temperature.

While the power distribution system 500 and power cable assemblies 100, 200 of the present disclosure have been described in terms of the preferred embodiments thereof, it is not intended to be so limited, but rather only to the extent set forth in the claims that follow.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A high voltage power cable assembly comprising:
an electrical conductor;
a first insulating layer surrounding the electrical conductor; and
the electrical conductor extending longitudinally between first and second end contact surfaces configured for coupling via first and second connectors to respective electrical connections, wherein the electrical conductor comprises an internal surface and an external surface and a conducting body therebetween, wherein the internal surface defines an interior channel between a first end opening and a second end opening configured for receiving a dielectric coolant from a cooling system arranged in communication with the conductor, and wherein the internal surface is a heat transfer surface arranged to be in direct contact with the dielectric coolant for transferring heat from the conducting body to the dielectric coolant.

2. The power cable assembly according to claim 1, wherein the electrical conductor is of a tubular or cylindrical form.

3. The power cable assembly according to claim 1, wherein the electrical conductor comprises a busbar.

4. The power cable assembly according to claim 1, wherein the electrical conductor is comprised of a metal material.

5. The power cable assembly according to claim 4, wherein the metal material comprises one or more of the following:
(i) copper, copper ETP, and/or a copper alloy; and
(ii) aluminium, and/or an aluminium alloy.

6. The power cable assembly according to claim 1, wherein the first insulating layer envelops the external surface of the electrical conductor.

7. The power cable assembly according to claim 1, further comprising:
(i) a shielding layer surrounding the first insulating layer; and
(ii) a second insulating layer external to the shielding layer.

8. The power cable assembly according to claim 7, wherein the shielding layer comprises one of braid, pipe, or bundle shielding.

9. A cooling system configured for coupling with the power cable assembly according to claim 1, the cooling system configured to circulate a coolant between a coolant inlet and a coolant outlet, via the interior channel of the electrical conductor, the cooling system comprising:
a pump;
a cooling unit; and
one or more connectors for connecting the coolant inlet and the coolant outlet to the power cable assembly; wherein the coolant comprises a dielectric coolant circulated in direct contact with the heat transfer surface of the electrical conductor.

10. The cooling system according to claim 9, wherein the dielectric coolant is thermally coupled to the heat transfer surface of the power cable assembly to provide heat transfer therefrom to the coolant.

11. The cooling system according to claim 9, wherein the dielectric coolant comprises a dielectric liquid.

12. The cooling system according to claim 9, wherein the dielectric coolant comprises one of the following:
(i) 3M FLUORINERT FC-43,
(ii) 3M NOVEC 7500, or
(iii) transformer oil.

13. The cooling system according to claim 9, wherein the dielectric coolant has a withstand voltage level of at least 6 kV.

14. The cooling system according to claim 13, wherein the dielectric coolant has a withstand voltage level of at least 1.5 kV.

15. The cooling system according to claim 9, wherein the coolant inlet and coolant outlet are located at opposite ends of the electrical conductor.

16. The cooling system according to claim 9, wherein the coolant inlet and coolant outlet are located at the same end of the electrical conductor.

17. A power distribution system comprising the power cable assembly according to claim 1 extending between first and second end contact surfaces configured for coupling, via first and second connectors, to respective electrical connections of the power distribution system and an integrated cooling system further comprising:
a pump;
a cooling unit; and
one or more connectors for connecting a coolant inlet and a coolant outlet to the power cable assembly, wherein the coolant comprises a dielectric coolant circulated in direct contact with the heat transfer surface of the electrical conductor for circulating the dielectric coolant between the coolant inlet and coolant outlet of the interior channel of the electrical conductor.
